(19) United States
(12) Patent Application Publication
(10) Pub. No.: US 2007/0050511 A1
(43) Pub. Date: Mar. 1, 2007

(54) Maintaining personal records

(76) Inventor: Javana Gamuna Dias, Surrey (GB)

Correspondence Address: RICHARD M. GOLDBERG, 25 EAST SALEM STREET, SUITE 419, HACKENSACK, NJ, 07601, US

(21) Appl. No.: 11/209,300

(22) Filed: Aug. 23, 2005

(51) Int. Cl. G06F 15/16

(52) U.S. Cl. 709/229

(57) ABSTRACT

According to an aspect of the present invention, there is provided a method of maintaining personal records for customers held by service providers. Authenticated personal information is received at a first service provider via a first networked portal. In many situations, the received personal information may be associated with transactional data specific to the first service provider. However, in addition, an authorisation is received from a customer so as to allow the networking of a second service provider via a second networked portal. Authenticated personal information is supplied from the first portal to the second portal. Furthermore, an updating process is performed such that the authenticated personal information may be updated at either the first portal or the second portal (in response to receiving a customer-instigated modification) resulting in an updating of the data at the other of the first portal or the second portal.

### BACKGROUND OF THE INVENTION

The present invention relates to maintaining personal records for customers held by service providers.

A schematic representation of a prior art environment is illustrated in Figure A. Personal information is received by a retailer A1, a first insurance company A2, a second insurance company A3, a pension provider A4, a bank A5, a credit card company A6 and an employer A7. In theory, and as appropriate, the personal information should be substantially the same at each of the service providers. However, over time, it is possible that some will receive updates whereas others will not. Consequently, some of the information held with some of the service providers may become out of date; usually to the detriment of both the customer and the service provider themselves. It is therefore appreciated that in an environment of this type it would be preferable for all of the information to remain in an updated state.

An alternative environment that attempts to provide a solution to this problem is illustrated in Figure B, identifying the same service providers. In this environment a user provides personal details to a central server B1 and then each of the service providers in turn may be given access to this information. However, a known problem with environments of this type is that the owner of the server B1 is placed in a very high position of trust and it is therefore unlikely that a significant take-up rate would be achieved.

### BRIEF SUMMARY OF THE INVENTION

According to an aspect of the present invention, there is provided a method of maintaining personal records for customers held by service providers. Authenticated personal information is received at a first service provider via a first networked portal. In many situations, the received personal information may be associated with transactional data specific to the first service provider. However, in addition, an authorisation is received from a customer so as to allow the networking of a second service provider via a second networked portal. Authenticated personal information is supplied from the first portal to the second portal. Furthermore, an updating process is performed such that the authenticated personal information may be updated at either the first portal or the second portal (in response to receiving a customer-instigated modification) resulting in an updating of the data at the other of the first portal or the second portal.

### BRIEF DESCRIPTION OF THE SEVERAL VIEWS OF THE DRAWINGS

FIG. 1 shows an environment embodying an aspect of the present invention;

FIG. 2 shows an example of the physical structure of a personal portal;

FIG. 3 indicates procedures performed at a terminal device;

FIG. 4 shows a personal portal data record;

FIG. 5 shows an overview of procedures performed by a computer at a portal host location;

FIG. 6 shows a procedure for the sharing of data over the personal portal network;

FIG. 7 shows a schematic representation of a personal portal network;

FIG. 8 shows a procedure for the processing of received data at a portal; and

FIG. 9 shows a procedure for the analysis of profile data.

### WRITTEN DESCRIPTION OF THE BEST MODE FOR CARRYING OUT THE INVENTION

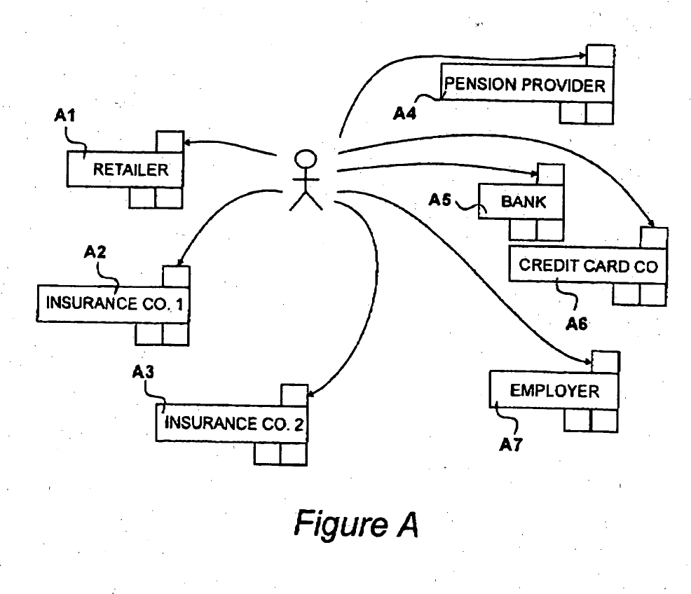

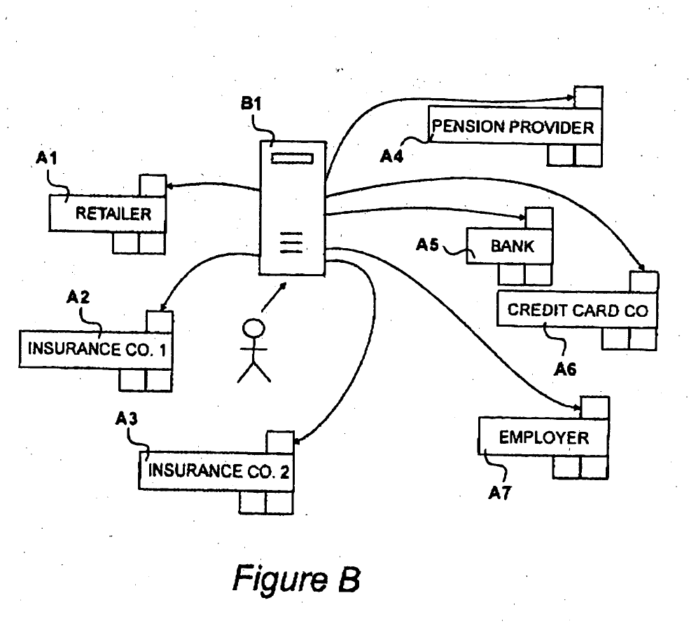

FIG. 1

An environment embodying an aspect of the present invention is illustrated in FIG. 1. In the course of normal day-to-day activities, a user provides personal information to a retailer 101, a first insurance company 102, a second insurance company 103, a pension provider 104, a bank 105, a credit card company 106 and an employer 107. For the purposes of illustration, a first organisation to be approached is, say, a bank 105. At the bank 105, the user requests the establishment of a personal portal; this consisting of a networked portal that (according to certain rules or principles; examples of which are described below) may communicate and share data with similar portals within a network. Thus, in addition to establishing a first personal portal, the first personal portal (at bank 105) also receives an authorisation from the user (customer) so as to allow a network connection to be established with a second service provider via a second network portal; for example the credit card company 106. In this way, it is then possible for the authenticated personal information received at the first portal to be transferred, over a network 111 to the second portal (at the credit card company 106).

In addition, personal information may be subsequently updated at the bank 105 or at the credit card company 106; prompted by submissions made by the customer. The updating of the authenticated personal information at either the first portal (the bank 105) or the second portal (credit card company 106) results in the data maintained at the other portal being updated automatically. Furthermore, as illustrated in FIG. 1, this approach may be extended to all of the service providers once personal portals have been established and authorisation has been given for communication between them to take place.

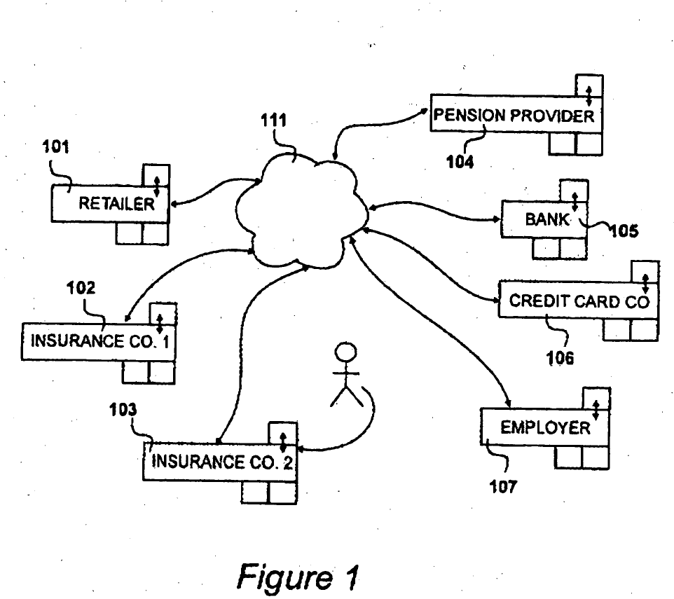

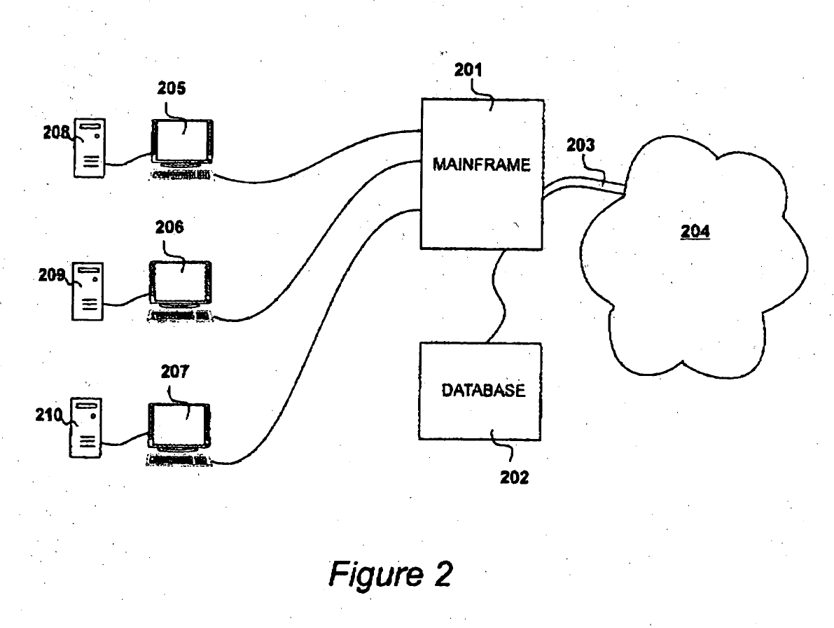

FIG. 2

An example of the physical structure of a personal portal is illustrated in FIG. 2 which, for the purposes of illustration, may represent the structure of apparatus retained at the bank 105.

At the bank 105, a mainframe computer 201 is maintained that has access to a large local storage device or database 202 and a connection 203 to an external network 204 which, for example, could be the Internet.

Personal information is received from customers via terminal devices 205, 206 and 207. These terminal devices 205 to 207 are also connected to respective data authentication devices 208, 209 and 210. These devices, for example, may be configured to receive identity cards and to compare information held on these cards with information supplied by the customer. Thus, this could include biometric data (such as iris pattern data) which is compared with an iris scan during the procedure for establishing the personal portal. It is appreciated that when a portal is first established, it is essential to take every available measure to ensure that identity is correct. However, it can be appreciated that the ability to share information within the network removes a significant burden upon the customer in terms of providing this identity assurance many times. Thus, having once provided authenticated data concerning a change of address, for example, this information will be automatically transmitted to other organisations using the portal system and further burdensome updates and modification processes are removed from the customer. However, in addition, the service providers may be assured that the data they hold is maintained up to date without requiring expensive further data receiving procedures.

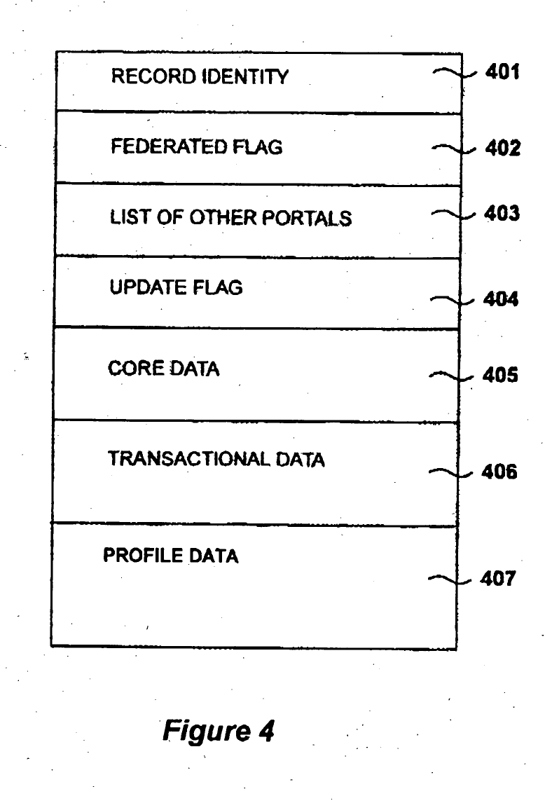

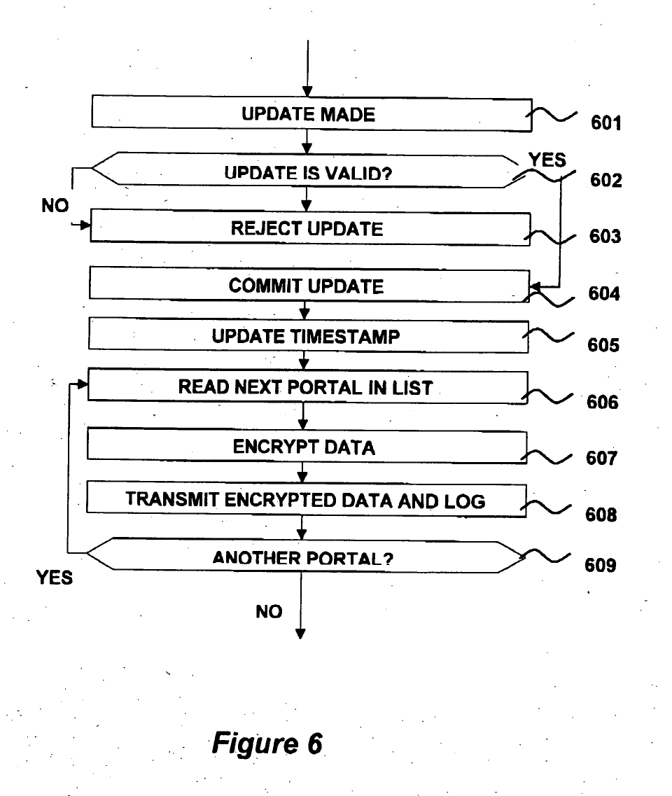

It is envisaged that the structure shown in FIG. 2 normally operates in the local mode described above, being in a position to receive information (see 405, 407 later with reference to FIG. 4) from customers via terminals 205 to 2007, download information to the mainframe computer 201 and in turn update and maintain database 202. Periodically, or concurrently it is possible for sharing processes (detailed with respect to FIGS. 6, 7 and 8) to allow locally updated data to be transmitted to other portals via network 204 and, similarly, for data modified elsewhere to be received from network 204 and used to maintain accurate records within database 202.

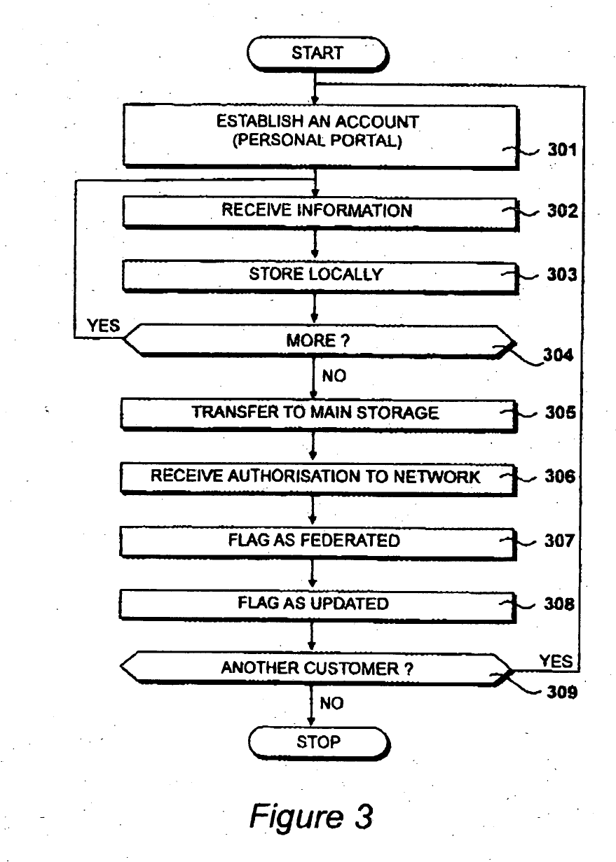

FIG. 3

Procedures performed at a terminal device, such as terminal 205, are detailed in FIG. 3. At step 301 measures are implemented to establish a personal portal account, which as previously described, involves checking the identity of the customer proposing to open the account (in detail, and preferably with reference to bio-metric information). The opening of an account may represent a first account, that is to say the opening of a first personal portal facility, and when first opening an account more extensive measures may be taken in order to complete the identity check. Subsequent accounts, opened with other service providers, require similar checks but these would be performed as part of the procedure for extending the network within the overall virtual personal portal.

Having established the account at step 301, the terminal 205 receives authenticated personal information (see 405, later in FIG. 4) from the user, usually requiring manual input from an operator or from existing data already held by the service provider. This information would typically include the customer's full name, address, telephone number and other relevant communication related information, certain items of information being mandatory. Further personal details may be required such as date of birth, or for example other information such as commercial and communication preference settings and the extent to which these are required may depend upon the particular service being provided.

At step 303 the information received from the customer is stored locally in a prescribed format identical across all portals and at step 304 a question is asked as to whether more information is to be received in order to complete the transaction. Thus, when answered in the affirmative, further information is received at step 302 or, alternatively, in response to a negative response at step 304, the information received is transferred to main storage at step 305. Thus, when the information reception has been completed, data is transferred from terminal 205 to the mainframe computer 201 which in turn updates database 202.

At step 306 the customer is invited to provide authorisation to the effect that the information may be networked. In the majority of situations it is anticipated that this question would be answered in the affirmative and the flag in the data is set accordingly. However, under some circumstances, the customer may wish to establish a portal for data to be held locally (at least for a temporary period) before network access is approved.

Thus, having received authorisation to transmit the information to other authorised portals, a flag is set at step 307 to the effect that the data may be federated across the personal portal network.

At step 308 a further flag is set to the effect that the data has been updated. Thus, newly created data is treated as being updated such that, when operating in its networked mode, the data may be transmitted to other portal providers when they in turn have been given authorisation (by the customer) to receive it. In a preferred embodiment, a time is also recorded at step 308 (with reference to a shared clock, common to all personal portals on the network). This time information is maintained with the newly updated information, in the form of a timestamp, to be described later with reference to FIG. 6.

At step 309 a question is asked as to whether another customer is to be processed and when answered in the affirmative control is returned to step 301.

FIG. 4

The interaction of a customer with terminal equipment 205 (as illustrated in FIG. 3) results in the creation of a data record, as illustrated in FIG. 4.

A typical data record includes a record identity 401, unique to that record thereby allowing the record to be identified and indexed within the database system 202.

At step 402 a federated flag is included, set when the customer has given authority for the data to be federated to other portals within the environment.

Area 403 includes a list of the other portals to which authorisation has been given. (The list at 403 may include in addition a subset of permissions, normally set by the customer, indicating levels of access to personal information, for example restricting access to certain categories of information for certain portals.) Thus, if a customer has established a portal with respect to bank 105 and with respect to credit card company 106, a data record held at the bank 105 will include reference to the credit card company within list 403. Similarly, at the credit card company 106 a similar record will be held but for this instance the list 403 will include reference to the bank 105. In this way, it is possible for data to be updated at either portal, which will then result in the data being updated at the other portal (and similarly to all portals approved for access to that category of information). At the source portal update flag 404 is set and then when networking procedures are carried out, flagged data will result in the record (including fields 402, 403, 405) being transmitted to the other authorised and federated portals. In the preferred embodiment, (at whichever portal the actual update was made) the updated flag includes a time stamp indicating when that update was made by the customer.

The record contains core data which may be considered as the personal data previously discussed. Thus, this core data is the data established by the customer and authorised by the customer for distribution to other providers within the network. In a first embodiment, the distribution of data is relatively straight forward in that each authenticated portal may receive all of the core data. However, in alternative more sophisticated environments, it is possible for the data to be marked in such a way that portals within the environment are treated differently; further details of which are given below.

In addition to the core data 405, the service provider themselves will generate transactional data and this is stored within region 406. This transactional data is usually known to the customer but cannot be modified directly by the customer. It includes details of transactions such as bank account transactions, credit card transactions etc and the personal portal rules, or principles ensure that this information normally remains associated (in the same record) with the core data and is not normally transmitted or shared between service providers without the customers permission.

In addition to the above, region 407 provides for the storage of profile data, which may include more descriptive details of customer activity. Profile information may include for example commercial preference information provided by the customer and/or inferred or derived information calculated by the portal host company. Thus, this profile data could be established with reference to the core data 405, transactional data 406 and other externally generated data, such as demographic data received from an external source. Customers may also be provided with access to the profile data 407, thereby allowing them to update it and provide appropriate additions. Thus, a customer may establish within their profile data that they are presently interested in a particular service such that when notifying customers of particular offers, the relevant information may be derived from the profile data and appropriate information then is distributed to customers; as described with respect to FIG. 10.

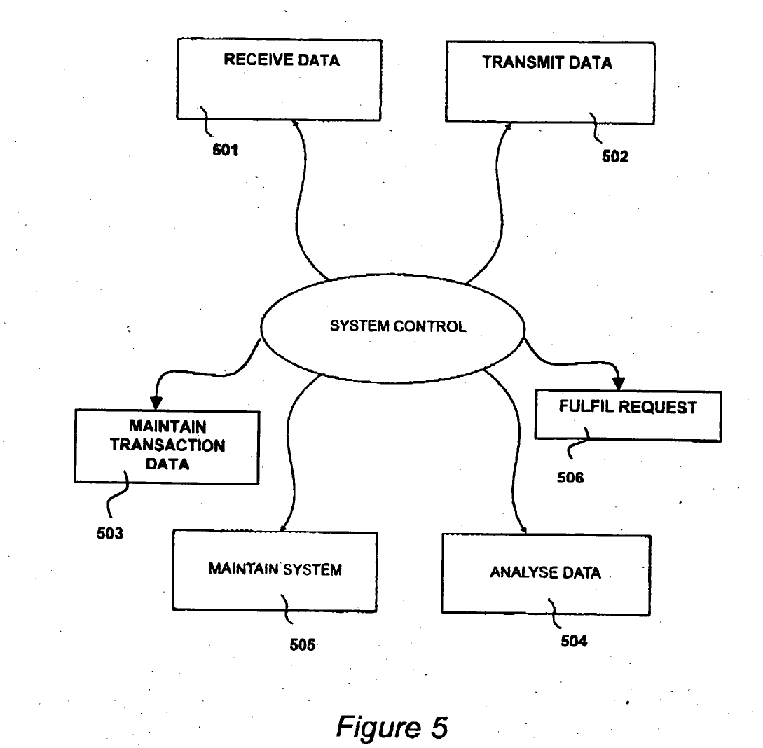

FIG. 5

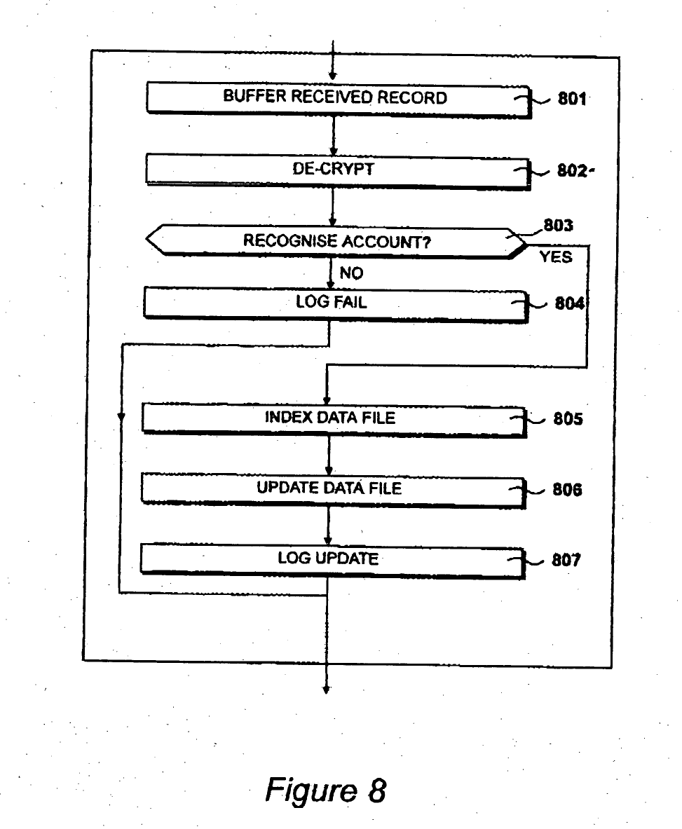

An overview of procedures performed by mainframe computer 201 is illustrated in FIG. 5. A system control process maintains overall control of the system and determines which particular processes may be performed and, in a preferred embodiment, in which order of priority and in which time interval. (In an alternative embodiment, the system control is managed by a family of web services, which allow concurrent, or almost concurrent transaction activities to be processed with database integrity on a sequential processor.) A process 501 relates to the reception of data as previously described with respect to FIG. 3. Periodically, and preferably on a regular basis according to a shared clock information may be received by the portal. When a valid update is available for transmission (using a process similar to step 502) from a portal, and the portal of FIG. 6 is authorised to receive the data, the data is received and processed by process 501 as detailed later with reference to FIG. 8.

Procedure 502 facilitates the sharing of data with other authorised portals over the network and, in a preferred embodiment, this is performed synchronously, on a regular basis with reference to a shared clock. On receipt of a new update, for example from terminal 205, 206 or 207, the updated portal queues and transmits updates to all other portals (according to the portal list 403). The process is further detailed with reference to FIG. 6. The data is received by the other portals according to a process similar to 501. Process 503 provides for the updating of transaction data by the service provider. This may also be performed on a regular basis, and transaction data may be shared with the customer.

Process 504 facilitates the analysis of the existing data and so creates Profile data which may in turn allow customers to receive tailor-made communications or at least communications which are considered to be of interest to them; thereby providing a significant cost saving over the established approach of a mail shot to every address held within the database.

A procedure 505 exists for facilitating system maintenance which may be required as repairs are needed, expansions are made or modifications established to operational procedures.

A procedure 506 exists to fulfil requests for information from other suppliers in the network. This allows any portal to exist as a referee for a customer who maintains a portal with that service provider. For example, a mortgage lending company may request a copy of certain transaction or profile data from a bank (for example, this customer has maintained a positive balance over the past 12 months), and this transmission may be allowed, where previously authorised by the customer.

Processes 501 to 506 are normally performed sequentially, or with separate operations called on a regular basis according to a shared clock. However, on occasion, multiple requests may accumulate in the system, resulting in contention over the portal record. A system of prioritization as to how to process those requests is implemented and is discussed later.

FIG. 6

Procedure 502 for the sharing of data over network 204 is detailed in FIG. 6. In the preferred embodiment, the transmission of data is controlled such that the system tends towards an equilibrium state, by only permitting one portal at a time to break out of equilibrium state and then all other portals adopting the new state set by that portal.

The equilibrium state exists when the shared data, together with the accompanying timestamp information is identical at all authorised portals.

In this embodiment the transmission of data is synchronised such that, at any point in time, only one portal transmits data while other portals in the network are available for the reception of data.

Furthermore, records are transmitted sequentially and when transmitting data for a particular record, specific recipients are transmitted to sequentially. In this way, the integrity of the data is maintained and log files are maintained both at the transmitting station and at the reception station so as to maintain a full audit trail.

At step 601 a customer selects a portal in the network and updates the data at that portal, for example via terminal 205. If the changes are valid (the network being previously in an equilibrium state) as checked by step 602, the portal records those changes into its database in step 604 and updates the last updated timestamp to reflect the exact time of new information update at step 605. Should the changes be invalid they are rejected at step 603.

The equilibrium state is now broken with the newly updated portal carrying an updated timestamp that is more recent than all others in the network. This newly updated portal is now known as the master portal. The master portal places the updates to be made, together with the list (403) of portals to be updated into a queue and sets a flag indicating a new update is available for transmission.

At steps 606, 607, 608 and 609, newly updated data is transmitted to each authorised portal in turn, according to the list of authorised portals at 403 until all portals on the list have been updated.

When an update record is received by a receiving portal as in process 501, it first checks that the update is valid—by checking that its current last updated timestamp is equal to the last updated timestamp from the previous master. If this is not the case, then it was not in an equilibrium state and there is the potential for error in the system. Thus, the portal network provides for notifying any concurrent or almost concurrent update activity at different portals, it being highly unlikely that an individual customer is updating information at more than one location at once.

If the portal network was in equilibrium, then each receiving portal supplier will then receive, prioritize, queue and commit changes to the portal. It will then update the last updated timestamp to match that of the master.

When all authorised portals in the customer's personal portal network have received the update, the system is in the equilibrium state once again and the master ceases-further transmission of update data.

If one or more receiving portals are unable to receive the transmission, commit and confirm the update, the customer's personal portal network will remain out of equilibrium. In this case the system will continue to try to regain the equilibrium state or after a certain period or number of attempts will report an error.

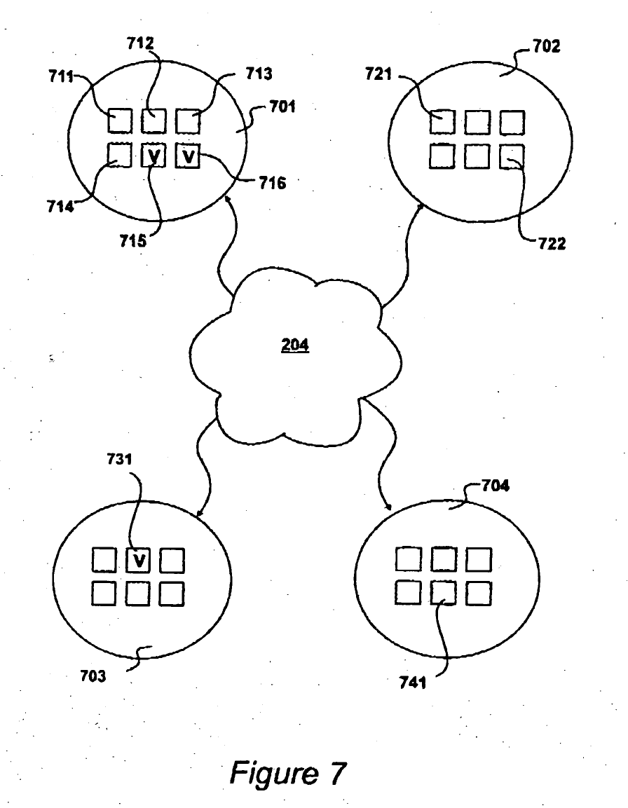

FIG. 7

A schematic representation of the network is illustrated in FIG. 7. In this example, four portals 701, 702, 703 and 704 mutually communicate via personal portal network 204. In this simplified example, each portal 701 to 704 has six record sets representing the details of six respective customers. Thus, at portal 701 records 711 to 716 are present. Furthermore, records 715 and 716 have been modified recently, identified by their respective update flags 404 being set.

Furthermore, for the purposes of this illustration, it is assumed that the customer for record 715 has established a portal at supplier 702 (record 721) and has established a portal at supplier 704, resulting in data set 741.

For the purposes of this example, an update has been made to the core data at portal 715 at supplier 701. For the customer who owns portal 715 and also 721 and 741, the portal network is out of equilibrium as evidenced by non-equal timestamps across portals 715, 721 and 741. An instruction to transmit this change to the other two portals is placed on an outbound queue at portal 715, by the mainframe computer at supplier 701. This instruction is executed and the update on portal 715 is transmitted to portals 721 and 741 and the system thus returns to the equilibrium state.

In a second example, an occurrence of an update conflict is illustrated: A second customer of supplier 701 has a portal resulting in data record 716 and a portal at supplier 703 resulting in data set 731 and also a portal at supplier 702 resulting in record 722.

A change is made at supplier 701 to portal 716 and an instruction is placed on the queue for 701 to transmit that change to the customers portals at supplier 702 to portal 722 and another to transmit to supplier 703 to portal 731.

However, before those changes can be transmitted by supplier 701, a change is also made to the data at portal 731 at supplier 703. Before accepting that change to portal 731, supplier 703 will check the last updated timestamp to ensure that the system was in equilibrium. As the last updated timestamp for portal 716 is more recent than that shown by portal 731, supplier 703 will not commit that change and will reject the update (notifying one or both of the customer and the portal host of the rejection and thus indicating possible fraudulent activity).

When the transmission of the update has been made and received by portal 731, the timestamps will be equal and equilibrium achieved. At that time the rejected update made to portal 731 at supplier 703 can be attempted once more at the instigation of the authenticated customer.

FIG. 8

Procedure 501 for the processing of received data is detailed in FIG. 8. At step 801 the received record is buffered and then decrypted at step 802. It is assumed that a high standard of encryption will be deployed so as to ensure that messages transmitted over the network 204 cannot be intercepted and decoded. It is also appreciated that the particular type of encryption used would be modified over time.

At step 803 a question is asked as to whether the account is recognised and if answered in the negative a log record is created to the effect that a failure has occurred at step 804.

If the account is recognised and the question asked at step 803 is answered in the affirmative, the update request will be placed in a queue of update requests for that portal. The position in the queue may depend upon several factors, for example the time of the request, the source of request, the type of request and the significance of the requestor. Updates to core information transmitted from another portal (process 502) for that customer are normally allocated priority second only to internal maintenance transactions (process 505)

The data file held within the local database 202 is indexed at step 805 so as to locate the record of interest.

At step 806 the record of interest is updated and the last updated flag is also updated, to match the timestamp from the master portal making the update. At this point the updated portal and the master portal return to an equilibrium state.

At step 807 information relating to the update is written to a log file.

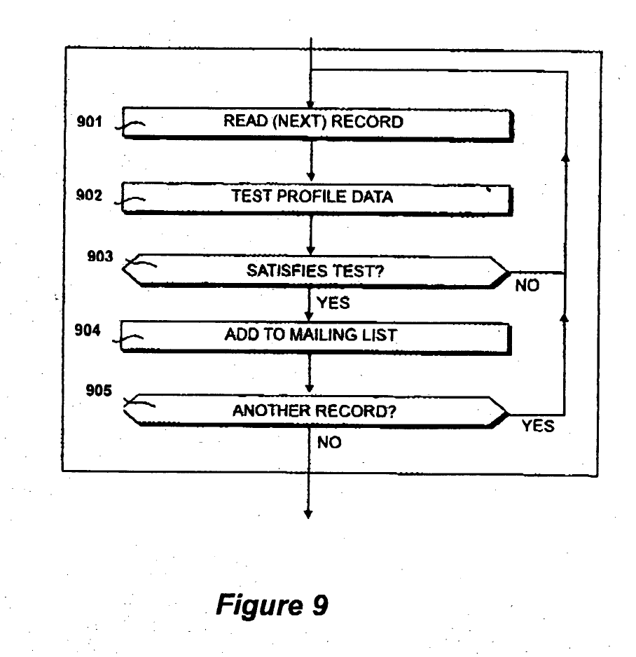

FIG. 9

Procedures 504 for the analysis of data has been identified in FIG. 5 and these are detailed in FIG. 9.

At step 901 a record is read and at step 902 a test is performed upon its profile data. At step 903 a question is asked as to whether the data tested satisfies the test and if it does not the question is answered in the negative resulting in control being returned to step 901 and the next record being read.

If the question asked at step 903 is answered in the affirmative, to the effect that the record does satisfy the test, details of the customer are added to a mailing list at step 904. Thereafter, at step 905 a question is asked as to whether another record exists and if answered in the affirmative control is returned to step 901.

Operational procedures

A platform described above provides a powerful environment in which personal information may be managed securely to the advantage of all concerned. However, it is appreciated that in order for effective deployment to occur, it is necessary to establish design principles and rules for operation. The design principles will translate into the principles of personal information management; these being a set of principles that apply differently to all customers of the personal portals system.

It is proposed that the information about an individual, that is to say the identity owner, is the property of that individual or customer. Certain information such as profile information about an identity owner that is captured and held by a trusted intermediary or supplier may be considered as being in joint ownership between the identity owner and the trusted intermediary.

It is proposed that information captured and held by a trusted intermediary can be analysed and used by the trusted intermediary to conduct its own business activities, although the nature of these business activities should be defined and declared in the contract between the trusted intermediary and the customer or identity owner.

It is proposed that the identity owner specifies preferences for interaction and communication in the core identity information or contact details. A third party must be registered with any portal host that manages an identity owner's portal to be able to be granted permission to interact with the identity owner via their personal portal. As previously described, the registration process for a customer will include a piece of real world authentication to provide assurance of valid identity.

It is proposed that a set of default permission preferences may be provided that will address the needs of the majority of identity owners. However, the ability to customize the permissions set will be available to all users via a user interface. Furthermore, an identity owner can give a trusted intermediary or another identity owner permission to manage their permissions on their behalf.

Process for Creating and Registering a New Portal Host

Each portal host is linked into the network and authenticated. This is normally done by a central governing body, which may be known as the board of portal hosts. Upon successful registration, the host is given a unique portal host ID. The portal host is expected to agree to conditions to ensure compliance with the principles of personal information management.

Physical World Authentication

It is likely that authentication would require some form of identity card or device where the users identity can be confirmed prior to the setting up of a personal portal. If a biometric scan is performed, the portal host must be sure that this represents the identity owner. The scanning process produces a public biometric key that is held as part of the core information for a personal portal. The private key is the person themselves or rather the part that is subjected to the biometric scan.

Creation of Portal Host Access

The identity owner will access their first personal portal and create a record that will allow other portal hosts access to the first portal to pick up the core information that includes the public biometric key. The identity owner signs in with update access and generates permission for another portal host to join the personal portal network. This sets the new portal host up as a host and generates a public key that the identity owner can pass to the new portal host.

Permissions may be held in the identity owner's portal network information, in a list of all portal hosts hosting personal portals for that identity owner. These may have various state flags attached to them, for example the role of that portal host with respect to the identity owner. When the identity owner creates access for a portal host a new record may be added to the list of portal hosts. The generated public key is specific to a single portal host and valid only to allow them to set up a personal portal that they will host.

Setting up a Personal Portal

When the identity owner's identity has been validated, a portal host is able to set up a personal portal and link it into other portal hosts who also host portals for that identity owner.

The identity owner and portal host should create a contract that determines the nature of that relationship. The board of portal hosts will approve a limited set of contracts to simplify this operation.

When an identity owner creates a portal host access key, the portal host's record may be added into the portal network information. Details such as the type of contract and expiry date should also be held there. When the identity owner is presented with the contract, they may reply with the portal host's access key, which acts' as their signature.

Updating Core Information

The authenticated identity owner is able to update core information. The identity owner with update permission signs-in after a biometric scan that presents the private key. The identity owner is then in a position to make changes to the core information, which subsequently propagate around the network as described.

Updating Transactional Information

As an identity owner performs new transactions with a portal host, these transactions are used to update the transactional information part of the personal portal. In certain cases the update will be in real time and in other cases there may be a delay; this being determined by the portal host's policy. The aggregation of detailed information is also considered and will be a function of when that information will be used, what it is used for and the frequency of use.

Updating Profile Information

As core data and transaction data increases in volume, the portal host is able to build a profile of the identity owner, inferred from the data and representing for example potential commercial preferences of the identity owner. The profile may be augmented by data supplied by data providers inside and outside of the system. This is similar to overlaying of identity owner data with demographic behavioural profiles. It is appreciated that this overlaying process is not fully accurate therefore the identity owner should be permitted to see and amend profile information, which is considered to be in everyone's best interest and adds significantly to the value (relevance) of the profile information.

The Issuance of Keys

If an identity owner issues a key to another customer, the key will contain elements specific to both parties to ensure fully authenticated access. If the key is issued to a third party who is not a customer, they will be treated as a marketer and will need to be recognised by at least one portal host in the customer's personal portal network, before being allowed to establish communication with the customer via the personal portal network, according to certain rules, such as the user-preferences set by the customer.

Proposed Components of an Identity

As previously described, there are three information types that make up an electronic identity, comprising core identity information, transactional information and profile information. Core identity information should include full name, addresses (personal, mailing and business etc), date of birth, telephone contact numbers, fax number, email addresses and payment information such as credit card numbers with associated identification numbers and validation codes.

Core identity information takes an identified format in any personal portal so as to ensure that the core identity information can be accurately maintained across the individual's federation of personal portals using the propagation model.

Transactional information will be the most granular data that an organisation is prepared to keep about an individual. This information may be held in any format that is convenient and effective for the portal host.

Profile information is information derived from transactional information, core identity information and acquired data. It may also include overrides to derived information as defined by the individual. The overrides will state personal preferences such as how to communicate with the identity owner or what type of products and services the identity owner has expressed an interest in receiving information about. Thus a communication channel controlled by the personal portal network may allow highly focussed marketing information to reach the customer, but would not allow unsolicited and/or unwanted communications such as ‘spam’.

Granting Permissions

It is proposed that only the identity owner is able to grant access permissions to information held within their personal portal. Certain permissions will be granted to the portal host implied by their agreement to act as a portal host for that identity owner. The identity owner is only able to directly grant access permissions to aspects of their core information but not to transactional or profile information. To grant permission to create a new personal portal with another portal host, stringent access checks will be required.

It is proposed that an identity owner may browse for new portal hosts on the network, whereafter they may select a host of choice and generate a public key specific to the new portal host. This public key would reside in a new record in the portal network information that represents the new personal portal of the new portal host. When the identity owner presents themselves to the new portal host, the portal host will perform a biometric scan that will allow them to create a new personal portal with core data from the existing personal portal.

Role Based Access Control

Role based access control is considered to be a set of rules that determine who is able to perform what actions on what pieces of information; providing the gateway for authorisation. Thus, before allowing any party to perform any action upon any piece of information, the rule set is consulted. The identity owner and portal host have final authority to establish the rule set; each of them being able to grant permissions on different aspects of the identity.

Propagation of Core Identity Information

Upon updating core identity information, an update type may be set too, in this instance, Source information, indicating that an update was done at a particular personal portal and an appropriate time stamp may be set. Subsequently, when data is transmitted to other portals, the originating portal will have the update type set to ‘Source’ while the rest will have an update type indicating ‘Propagated’. In this way, it is possible for a target personal portal to perform a time comparison. If the local clock shows a relative time later than the source time stamp, the update will be carried out. However, if not, an error condition has occurred and the propagation will not be completed.

Upon receipt of data, a target portal may send a confirmation of receipt. If the transaction completes successfully, the target may send a notification of successful completion of updates, again with a time stamp. In the preferred embodiment, time stamp information is all referenced to a single clock, shared by all the portal hosts on a particular personal portal network. This will reduce the opportunity for fraudulent updates to be made and committed.

In an alternative embodiment, a portal host may continually send out messages through other portal hosts while receiving messages from other portal hosts. Updates to the core identity information would be given a high priority and appropriate queues established, operating on a significance scheme, described below. Furthermore, transaction requests on any personal portal may be processed once all the received updates have been processed.

Transactions

In the early adoption stages, there are essentially two types of transaction facilitated by communication via the personal portal network to be defined. The first is a pull model where the identity owner initiates the process and a marketer responds. The second is a push model where the marketer identifies a potential prospect base and attempts to solicit them.

The Pull Model for Transactions

The pull model relies on the identity owner having accurately set preferences on their profile information. Thus, for example, if the identity owner is ready to purchase an automobile, the identity owner will access the personal portal that will facilitate car buying and select car preferences. These may include, for example, make, model, engine size, body style and more generic information. The identity owner will then select and specify their preferences.

Marketers are then invited by the portal host to solicit the identity owners with their propositions based on the identity owner's preferences. They may use the preference information to filter the propositions that they present to the identity owner. For example, a car dealership may have been invited to pitch their proposal to an identity owner. The car dealer ship may have a number of car options available but will only propose the car that the identity owner has specified an interest in.

If the car dealership presents a proposal outside the parameters specified by the identity owner, it may then be the identity owner's prerogative to revoke the channel of communication with the dealership. Thus, the identity owner's preferences, the profile information and the marketer's proposition data need to be held in a computable format. All parties should adopt a set of information standards that other parties who wish to participate are able to adopt.

When the marketer receives an invitation to solicit the customer, this comes in the form of a permission key that grants access to that marketer to access the portion of profile information about the identity owner that is pertinent to the proposition being offered by the marketer. The marketer is able to read in the profile data that the portal host creates and the preference parameters that have been set by the identity owner. The offer is sent out by the marketer to the portal host with an instruction to deliver this communication to the identity owner and the communication will come complete with the public key for the marketer and the identity owner. The marketer should specify how the reply from the identity owner should be prepared and be able to deal with the return communication. All communications should carry the public key that is specific to the marketer and the identity owner.

The Push Model for Transactions

The marketer may use the profile information to predict the needs of customers. Therefore if a customer is able to exactly specify their needs, the marketer will not need to guess.

Then portal host may use the transaction data to generate the profile data in exactly the same way as in the model described above; the transaction data is summarised to classify the identity owner into one of a number of segments, therefore normally bringing a set of typical characteristics and behaviours associated with those segments.

The marketer will be granted a key to view and analyse aggregated data and anonymous profile information. They may be able to specify selection criteria and how the result is reported back and then run a query. The results should be numerous in terms of identifying owners having certain characteristics or exhibiting certain behaviours. Consequently, the marketers will be able to gain a result on the number of (as yet unidentified) potential customers that fit a certain profile based on the information held by a specific portal host. Extending this approach, profile data can be aggregated across multiple portal hosts thereby further enriching the information.

If the marketer wishes to contact the target market, the query may be stored by the portal host and given a unique identification number. The marketer would then approach the portal host and ask to be able to contact the relevant customers. The portal host will rerun the query (without the customers being anonymous) thereby resulting in a list of identity owners. Identity owners who have expressed the desire not to be contacted will be stripped out and those who have specifically excluded a particular marketer will also be removed. This will leave a list of identity owners who do not mind being contacted by parties within the network. Thus, the marketer can then pass an offer to those identity owners by sending the proposition to the portal host, then having the portal host communicate with the identity owners. All such communications will carry the public key that is specific to the marketer and the identity owner.

Closed Loop Rejection

In the course of a dialog between a marketer and an identity owner via the personal portal network, if at any point the identity owner desires to terminate communication, the identity owner will be able to instruct the personal portal through which the marketer is communicating with them to cease forwarding messages from that marketer.

An experienced marketer, always expecting a certain proportion of identity owners to reject the proposition at certain points of the sales cycle will build a mechanism for rejection into their process. This will not only give the customer an easy way of terminating communications, but will simultaneously solicit their feedback as to why they desire to terminate the dialog.

Managing Contention

As the relevance of the personal portal network grows, there will be an increased amount of traffic on the network. Contention will become an issue where various customers of the system will demand a response service level on a request, especially if real time transactions are dependent upon the answer to a request.

An example prioritization system for handling contention upon a Personal Portal receiving a request is defined below:
a. Internal transactions (from within the Portal Host's system)
b. Propagation transactions (where the timestamp determines the priority)
c. Identity Owner transactions
d. Portal Host requests (within this set, the requests are prioritized using the scheme described that gives priority to the most significant requestor—see below)
e. Marketer requests

For Portal Host requests, the most significant requestor is a function of number of transactional records added in the past 12 months, the significance of the transactional data and the number of requests for information received in the past 12 months. This is expressed in a function;
Significance=(1/log₁₀T)×R²×√T
where T=the number of transactions and R the number of requests. The lower the significance value, the greater the commercial significance and therefore the higher priority the request.

1. A method of maintaining personal records for customers held by service providers, comprising the steps of
receiving authenticated personal information at a first service provider via a first networked portal;
associating said received personal information with transactional data specific to said first service provider;
receiving authorisation from a customer so as to network a second service provider via a second networked portal;
supplying said authenticated personal information from said first portal to said second portal; and
updating said authenticated personal information at either said first portal or said second portal in response to receiving a customer-instigated modification at the other of said first portal or said second portal.

2. A method according to claim 1, herein said authenticated personal information includes a full name and a residential address.

3. A method according to claim 1, wherein said personal information is authenticated with reference to officially generated proof of identity media.

4. A method according to claim 1, wherein said personal information is authenticated with reference to official held data derived from the biology of the customer.

5. A method according to claim 1, wherein said first service provider is a financial institution such as a bank, building society or insurance company; a utility such as a telephone company (land-line or mobile), energy supply or waste removal; or a merchandise company supplying goods or consumables.

6. A method according to claim 1, wherein said transactional data refers to commercial transactions between the customer and the service provider.

7. A method according to claim 6, wherein said transactional data is transmitted over a network from a first service provider to a second service provider only in response to specific authorisation received from the customer and is not updated in response to each modification.

8. A method according to claim 1, wherein said step of receiving authorisation from a customer, comprises the steps of said customer receiving a key-code from said first networked portal and supplying said key-code to said second networked portal.

9. A method according to claim 1, wherein each networked portal authorised by a customer retains an identification of other portals currently authorised by said customer.

10. A method according to claim 9, wherein each portal performs a regular check to identify recently modified personal data and, upon detecting a modification, transmits said modified data to the other identified portals.

11. Apparatus for maintaining personal records for customers held by service providers, comprising;
an input terminal for receiving authenticated personal information at a first service provider to establish a first networked portal;
a communication system for supplying authenticated personal information from said first portal to a second portal; and
a processing system configured to update authenticated personal information that either said first portal or said second portal in response to receiving a customer-instigated modification and the other of said first portal or said second portal.
